(19) United States
(12) Patent Application Publication
(10) Pub. No.: US 2015/0360360 A1
(43) Pub. Date: Dec. 17, 2015

(54) GAS FASTENING TOOL WITH RE-INJECTED AIR

(71) Applicant: ILLINOIS TOOL WORKS INC., Glenview, IL (US)

(72) Inventor: Christian RICORDI, Bourg Les Valence (FR)

(21) Appl. No.: 14/760,233

(22) PCT Filed: Dec. 26, 2013
(86) PCT No.: PCT/US2013/077833

§ 371 Date: Jul. 10, 2015

(30) Foreign Application Priority Data
Jan. 16, 2013 (FR) 1350361

(51) Int. Cl. B25C 1/08

(52) U.S. Cl. CPC B25C 1/08

(57) ABSTRACT

A gas fastening tool comprising an internal combustion engine including one combustion chamber, fuel injection means to inject fuel into the chamber and air injection means to inject air into the chamber, firing means for an air-fuel mixture within the chamber, reception means to receive a fastening element, one cylinder communicating with the chamber, forming together a combustion gas propagation pathway and wherein a piston is slidingly mounted so as to drive the fastening element, such tool being characterized in that it comprises a duct provided with a downstream input mouth and an upstream output mouth on the gas pathway, the piston stroke in the cylinder extending between the two duct mouths.

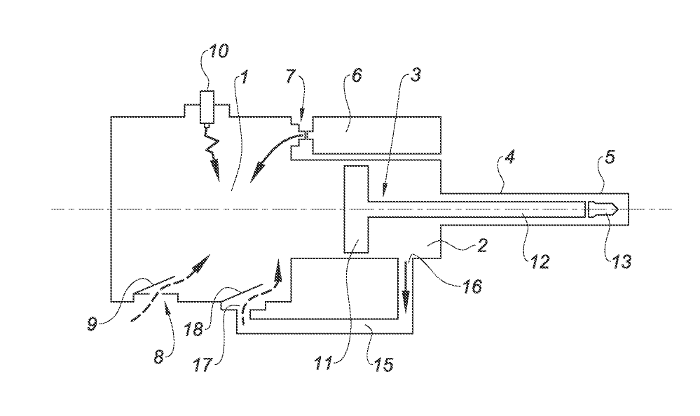

The invention relates to bedding or fixing tools or so-called gas fasteners, i.e. the tools comprising an “internal combustion engine” operating through firing within a combustion chamber an air-fuel mixture, the fuel being injected into the chamber by an injection device from a fuel container, a so-called gas cartridge. Such tools are adapted to drive fastening elements into support materials so as to fasten parts thereto. The gas nailing machines are today quite common. A fuel for an internal combustion engine includes for example petrol, alcohol under a liquid form, and/or gas.

A gas tool thus comprises essentially, within a housing, one combustion chamber, where fuel and air can thus be injected, one cylinder, downstream from the chamber, where a driving piston is moved, after firing, under the action of combustion gases, so as to drive a fastening element into a support material.

Pollution problems are considered nowadays with a strong acuity. And combustion gases of the gas bedding tools are polluting gases. That is why the Applicant has tried to solve such emission problem for such gases.

Thus, the invention relates to a gas fastening tool comprising an internal combustion engine including one combustion chamber, fuel injection means to inject fuel into the chamber and air injection means to inject air into the chamber, firing means for an air-fuel mixture within the chamber, reception means to receive a fastening element, one cylinder communicating with the chamber, forming together a combustion gas propagation pathway and wherein a piston is slidingly mounted so as to drive the fastening element, such tool being characterized in that it comprises a duct provided with a downstream input mouth and an upstream output mouth on the gas pathway, the piston stroke in the cylinder extending between the two duct mouths.

In other words, on the pathway of the combustion gases, the downstream input mouth is arranged downstream from the piston, while the upstream output mouth is upstream.

Thus, the fresh air that is with the cylinder under the piston, i.e. ahead the piston, during the piston stroke, is driven by it in the duct through the downstream input mouth to be re-injected upstream behind the piston, through the upstream output mouth.

Such fresh air re-injection, obviously being made after the mixture explosion within the chamber will nevertheless improve the completion of the combustion so as to make it more complete, thereby reducing the generation of polluting gases CO and NOₓ.

The upstream output mouth can be arranged either in the cylinder or in the combustion chamber.

Advantageously, such upstream output mouth is provided with a flap.

The invention will be better comprised with the help of the following description of the tool in accordance with the invention, referring to the sole accompanying FIGURE representing it in a sectional view under a schematic form.

The gas fastening tool to be described comprises one combustion chamber 1, one cylinder 2, one piston 3, one gun 4 extended by a tip-guide 5.

The tool comprises a housing 6 to receive a fuel cartridge being able to communicate with the combustion chamber 1 through an injector 7 provided for injecting, within the chamber 1, fuel from a cartridge being located in the housing 6. The chamber 1 comprises an air intake 8 provided with a flap 9. A sparkling plug 10 is dipped inside the chamber to cause a firing of an air-fuel mixture.

The cylinder 2 communicates with the chamber 1 and both form a propagation pathway for the combustion gases so as to propel the piston 3 towards the tool front. The piston 3 comprises a head 11 and a rod 12. The piston head 11 slides within the cylinder 2 under the action of the combustion gases, whereas the piston rod 12 slides in the gun 4.

A fastening element 13 having been introduced into the tip-guide 5, the piston rod 12, under the action of the propulsion gases, will drive the fastening element 13 into a support material.

The tool, as just described, is perfectly known from the man skilled in the art and does not need to be known anymore.

The tool according to the invention is distinct from those of the prior art with a duct 15 extending between a downstream input mouth 16 and an upstream output mouth 17 respectively arranged here at the front of the cylinder 2 and within the chamber 1. The upstream output mouth 17 is provided with a flap 18.

The input mouth 16 is located downstream from the piston head 11 and the upstream output mouth 17 upstream, both mouths being thus located on the combustion gas pathway. The stroke of the piston head 11 extends between the two mouths 17, 16. Thus, during the stroke of the piston 3 under the action of the combustion gases, after firing and explosion of the mixture, the fresh air being located under the piston head 11 is driven by such head into the duct 15 through the mouth 16 to be recovered in the chamber 12 by the mouth 17. Such fresh air will improve the completion of the combustion to make it more complete, thereby reducing the generation of polluting gases.

It should be noticed that the tool being just described could be equipped with a fan within the combustion chamber. It is a conventional arrangement for gas fastening tools.

1. A gas fastening tool comprising an internal combustion engine including one combustion chamber, fuel injection means to inject fuel into the chamber and air injection means to inject air into the chamber, firing means for an air-fuel mixture within the chamber, reception means to receive a fastening element, one cylinder communicating with the chamber, forming together a combustion gas propagation pathway and wherein a piston is slidingly mounted so as to drive the fastening element, such tool being characterized in that it comprises a duct provided with a downstream input mouth and an upstream output mouth on the gas pathway, the piston stroke in the cylinder extending between the two duct mouths.

2. The gas fastening tool according to claim 1, wherein the upstream output mouth is arranged within the cylinder.

3. The gas fastening tool according to claim 1, wherein the upstream output mouth is arranged within the combustion chamber.

4. The gas fastening tool according to claim 1, wherein the upstream output mouth is provided with a flap.
